(19) United States
(12) Patent Application Publication
(10) Pub. No.: US 2008/0035463 A1
(43) Pub. Date: Feb. 14, 2008

(54) Key button structure

(75) Inventors: Chih-Yuan Wu, Hsinchu City (TW); Tzu-Chih Lin, Hsinchu County (TW)

Correspondence Address: BIRCH STEWART KOLASCH & BIRCH, PO BOX 747, FALLS CHURCH, VA, 22040-0747, US

(73) Assignee: Altek Corporation

(21) Appl. No.: 11/598,697

(22) Filed: Nov. 14, 2006

(30) Foreign Application Priority Data
Aug. 11, 2006 (TW) 095214254

(51) Int. Cl. H01H 1/10

(52) U.S. Cl. 200/517

(57) ABSTRACT

A key button is provided for pressing against a metal dome to trigger a signal. The key button structure includes a button cap and a button stem. One tip end of the button stem is in a shape of spherical camber which is in point contact with the metal dome, so that the button stem, when being pressed, is within an effective pressing area of the metal dome to prevent the metal from being permanently deformed and damaged.

### CROSS-REFERENCE TO RELATED APPLICATIONS

This non-provisional application claims priority under 35 U.S.C. § 119(a) on Patent Application No(s). 095214254 filed in Taiwan, R.O.C. on Aug. 11, 2006, the entire contents of which are hereby incorporated by reference.

### BACKGROUND OF THE INVENTION

1. Field of Invention

The present invention relates to a key button structure for pressing a switch, and more particularly to a configuration and structure of a key button for pressing a metal dome of a membrane switch.

2. Related Art

Portable electronic devices, such as mobile phones, personal digital assistants (PDA), digital cameras, and multimedia players, have functions of remote communication, digital data processing, still and moving image capturing and music playing, etc., which satisfies different requirements of users respectively. Most of the portable electronic devices provided by vendors can meet users' demands functionally. However, under the market competition, how to provide portable electronic devices with various types of appearance and miniaturized volumes will become critical in attracting consumers to purchase.

The mobile phones, personal digital assistants, digital cameras, and multimedia players all need user interfaces such as touch screens, touchpads, or keys. A user may control a portable electronic device to perform its functions through the user interfaces. Among them, keys are the most commonly used as part of a user interface and the simplest in operation currently. The user can trigger corresponding actions simply by pressing keys. Under the requirement for miniaturized volumes of various portable electronic devices, the volume of keys cannot be too large. Thus, membrane switches with thin thickness are widely applied to various small portable electronic devices. The membrane switches are usually categorized into planar membrane switches, tactile membrane switches, and dome membrane switches, in which the dome membrane switches are provided with metal domes. When a metal dome is pressed, the metal dome is deformed to contact with a corresponding electrical conducting pad, and can recover after being released. Therefore, the dome membrane switches can provide good click feeling to the user when user presses the keys, thus dome membrane switches are becoming the commonly used membrane switches in various portable electronic devices, for example, a key button structure with a metal dome is disclosed in U.S. Pat. No. 6,911,608 and No. 6,967,300. A metal dome with an embossed side is shown in both FIG. 1 of U.S. Pat. No. 6,911,608 and FIG. 2 of U.S. Pat. No. 6,967,300. The metal dome has a button cap thereon, and the button cap has a button stem. The tip end of the button stem is planar, and presses the metal dome when the button cap is pressed, and the metal dome recovers after the button cap is released, as shown in FIG. 1. A currently used metal dome has a diameter of about 2.5 mm to 6 mm, a thickness of about 0.051 mm to 0.071 mm, a height from bottom to top of about 0.14 mm to 0.26 mm, and a maximum value of press displacement of about 0.10 to 0.20 mm. In order to maintain the effective resilience of recovery for the metal dome, an effective pressing area A, an allowable pressing area B, and a permanent deformation point C are defined from center to outer on the top surface of the metal dome 22. The maximum press displacement of the effective pressing area A is smaller than the diameter of the metal dome. When the button stem is correctly in contact with and presses against the effective pressing area A, the metal dome generates a reactive force of 130 to 150 gram force (gram-f) to counter the pressing force. When the button stem presses against in the allowable pressing area B due to manufacturing error, the metal dome has a reactive force of 80 to 150 gram-f which can still counter pressing force. However, when the button stem is in contact with and presses against the metal dome outside the permanent deformation point C due to the manufacturing error, the metal dome is permanently deformed and thus damaged. As far as the metal dome with a diameter of 2.5 mm in practice is concerned, the width of effective pressing area thereof is merely about 1.0 mm. Accordingly, the width of the tip end of the button stem must be less than 1.0 mm. During the manufacturing process of the button cap, it may be possible to control the size of the button stem. However, since the tip end of the button stem is planar, during the assembling process, the manufacturing error may cause the misalignment between the button stem and the center of the metal dome. When pressing the button cap, the button stem is in contact with and presses against the metal dome outside the permanent deformation point C and the metal dome is permanently deformed and cannot be used any more.

### SUMMARY OF THE INVENTION

As for a key button structure with a metal dome, the button stem to be in area contact with the metal dome has to be manufactured and assembled with great precision. The high manufacturing and assembling errors possibly result in, permanent damage to the metal dome in addition to the button stem pressing against the metal dome outside the effective pressing area thereof. Therefore, it is not the optimal design of key button structure with the metal dome. Therefore, the present invention discloses a key button structure design with a spherical surface in contact with the metal dome.

The key button structure disclosed in the present invention includes a button cap and a button stem. The surface of tip end of the button stem is in the shape of a spherical camber, and the button stem is extended toward a metal dome. When the button cap is pressed, the button cap moves the button stem to press against the metal dome. The spherical camber is in point contact with the metal dome, so that the button stem, when being pressed, is within a effective pressing area of the metal dome so as to ensure that the metal dome can resiliently recover after the button cap is released.

The key button structure of the present invention is provided for pressing against small-sized metal domes, and the surface of tip end of the button stem is formed in the shape of the spherical camber, such that the button stem is in point contact with the metal domes, thereby achieving a high accuracy of the button stem. Although slight dimension or assembling error exist, the button stem can still be in contact with and presses against the effective pressing area of the metal dome to prevent the metal dome from being permanently deformed and damaged.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a side view of a conventional metal dome;

FIG. 2 is a side view of an embodiment of the present invention; and

FIG. 3 is a side view of an embodiment of the present invention, showing the action of the key button structure.

### DETAILED DESCRIPTION OF THE INVENTION

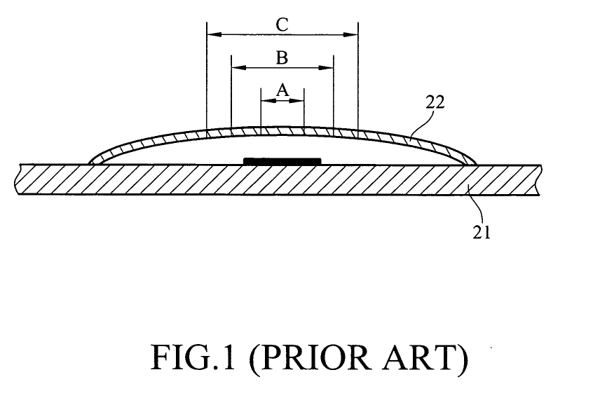

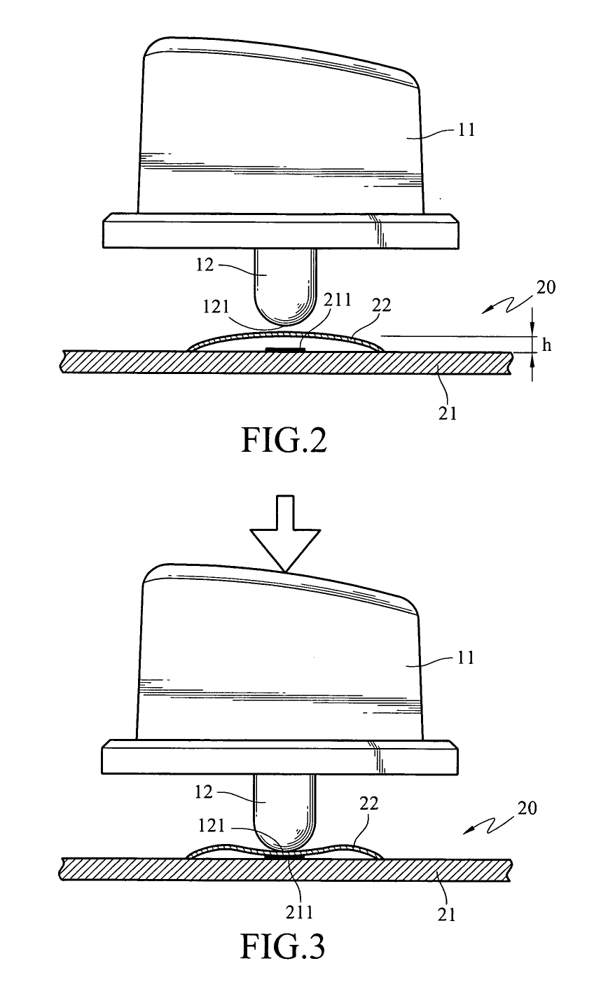

Referring to FIG. 2, a key button structure of an embodiment of the present invention is provided for a dome membrane switch 20. The dome membrane switch 20 includes at least a conductive layer 21 and a metal dome 22. The conductive layer 21 has electrical conducting pad 211. The metal dome 22 covers the electrical contact 211 and is formed by punching a metal plate to assume an embossed cap. The top surface of the metal dome 22 has a height h, such that in normal state the metal dome 22 keeps the height h from the electrical conducting pad 211 without touching the conducting pad. An effective pressing area A, an allowable pressing area B, and a permanent deformation point C are defined from center to outer on the top surface of the metal dome 22 (as shown in FIG. 1). When the effective pressing area A of the metal dome 22 is pressed, the metal dome 22 is deformed downward and the inner side of the top surface touches the electrical conducting pad 211. After force that makes the metal dome 22 deformed is absent, the metal dome 22 recovers due to the resilience. However, if the area outside the effective pressing area A is pressed, the metal dome 22 is permanently deformed and cannot recover when force is absent.

However, the key button structure of the embodiment of the present invention includes a button cap 11 and a button stem 12. The button cap 11 and button stem 12 are made of plastic material and formed by injection molding. The button cap 11 can be formed in any type of configuration according to the electronic device (not shown) in practice and is exposed outside the surface of the electronic device for users to press. The button stem 12 is extended from the bottom of the button cap 11, and has an outer diameter smaller than the outer diameter of the effective pressing area A. The surface of the tip end surface of the button stem 12 is in the shape of a spherical camber 121.

Referring to FIG. 3 together, the button cap 11 of the key button structure is disposed above the metal dome 22. The button stem 12 is extended from the button cap 11 and toward the effective pressing area A of the metal dome 22 and the tip end thereof is spaced from the metal dome 22. When the button cap 11 is pressed downward, the button cap 11 moves the button stem 12 to press against the metal dome 22. The spherical camber 121 of the button stem 12 is in point contact with the metal dome 22, such that the button stem 12, when presses the metal dome 22, is in contact within the effective pressing area A of the metal dome 22, and further the metal dome 22 is deformed downward to make the inner side of the metal dome 22 touch the electrical conducting pad 211. Thus, the conductive layer 21 triggers a corresponding signal at once. After force pressing the button cap 11 is absent, the button cap 11 returns to the normal position (through the resilient structure on the button cap 11 or resilient elements installed in the button cap 11, not shown). Then, the metal dome 22 can resiliently recover to the normal state (as shown in FIG. 2).

Since the surface of the tip end of the button stem 12 is formed in the shape of the spherical camber 121, so that the button stem 12 is in point contact with the metal dome 22. Although slight dimension or assembling error exist, the button stem 12 can still be in contact within and press the effective pressing area A to prevent the metal dome 22 from being permanently deformed and damaged.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A key button structure for pressing a metal dome to trigger a signal, comprising a button cap and a button stem extended from the button cap, wherein the tip end is formed in the shape of spherical camber, corresponding to the metal dome.

2. The key button structure as claimed in claim 1, wherein the metal dome has an effective pressing area, the outer diameter of the button stem is smaller than that of the effective pressing area.
